(19) United States
(12) Patent Application Publication
(10) Pub. No.: US 2017/0018142 A1
(43) Pub. Date: Jan. 19, 2017

(54) GAMING SYSTEM HAVING A MULTI-CARD VALUE WILD-CARD AND METHODS THEREOF

(71) Applicant: Steven T. Gold, Las Vegas, NV (US)

(72) Inventor: Steven T. Gold, Las Vegas, NV (US)

(73) Assignee: GOLD INNOVATIONS, LLC, Las Vegas, NV (US)

(21) Appl. No.: 14/799,900

(22) Filed: Jul. 15, 2015

(51) Int. Cl. G07F 17/32

(52) U.S. Cl. CPC G07F 17/3267; G07F 17/3293

(57) ABSTRACT

Gaming devices and methods of operating gaming devices are provided that include a multi-card value card that is playable as at least two card values (rank, or rank and suit). A signifying indicium is generated and displayed to indicate to the player that the novel wild card has been received. The signifying indicium may be a traditional card face or an identifying symbol or design. When a traditional card face is used, for example, all deuces may serve as novel wild cards. Methods are disclosed herein for providing the novel wild card in only a proportion of the decks to be dealt when an added card with an identifying symbol is used as the novel wild card. The novel wild card provides the player with a dynamic game play that will heighten the player's expectations and boost confidence in the likelihood of a winning result.

### CROSS-REFERENCE TO RELATED APPLICATIONS

14/62/029,909

### FEDERALLY SPONSORED RESEARCH

None

### SEQUENCE LISTING

None

### TECHNICAL FIELD OF INVENTION

The present invention relates to a gaming system having a multi-card value wild card that indicates a single card may be played as at least any two card values. A gaming system having emphasis on a specific card and suit each round with a variable value and suit indication.

### BACKGROUND

Electronic gaming devices are known to provide more profit to casinos than table games and are popular with casino patrons. Electronic gaming devices include both slot-type games and video poker games among other variations and embodiments of casino table games.

Slot-type gaming devices differ from video poker games in that the random number generator (RNG) of the slot machine is designed so that the machine pays out a percentage of the amount of money that is input into the machine (such as a 90-97% payback). In slot-type gaming machines the RNG is constantly in operation generating random numbers. The outcome of the game is determined by the particular random number generated at the exact microsecond that the player initiates the play. In contrast, the RNG of the video poker machine does not predetermine the outcome of the game, but instead enables the machine to emulate a deck of cards (generally fifty-two cards, such as would be used in play at a live table game with a dealer) by determining which of the cards will be the next one dealt. The RNG initially determines the deal cards when the player initiates the game (when the deal button is pressed). Replacement cards (or draw cards) for replacing the discarded cards may be determined when the player initiates the game (sometimes called “parallel dealing” because the second five cards were hidden “behind” the first five cards) or the remaining forty-seven cards may continue to be shuffled until the player presses the draw button, at which time the appropriate number of cards will be dealt from the deck to replace the discarded ones (sometimes called “serial dealing”).

From a player's viewpoint, slot-type games differ from video poker games in that slot-type games are based on luck while video poker games, even though randomly dealt, have added elements of skill and decision making, which tends to increase interest in the game. For example, in draw poker a player is dealt a hand of five deal cards. A player selects which deal cards to hold with the remaining cards discarded. Replacement or draw cards are then substituted for the discarded cards to yield a final hand. The final hand is then evaluated for wins based on the hand ranking category of the final hand (royal flush, straight flush, flush, four-of-a-kind, full house, flush, straight, three-of-a-kind, two pair, etc.) according to a predetermined list of payouts found on the “pay table” that is correlated to the number of credits bet.

Numerous variants of poker are known and played in the casino environment. These general types include straight poker, stud poker, draw poker and community card poker (such as Texas Hold 'em). The most common electronic video poker games are of the draw poker type with somewhat fewer of the stud poker type and fewer still of the community card poker type. However, popular online community card poker has aspects of both a live game and video poker, as it may be played against other online players, but the game is presented by a controller that provides the video display (and sometimes audio feed).

Electronic video poker games and live poker games may also be classified as wild card games and non-wild card games. In wild card poker games one or more cards are designated as “wild,” with the wild card allowing the player to more easily make a winning hand. Generally, a card designated as a wild card may be used by the holder of the card as a card of any value (any rank and/or any suit) without restrictions. Optionally, in some games a wild card may only be played as a “bug,” which has limited power in that it is not capable of substituting for any given card in the deck, but is given the rank of ace unless it completes a flush or straight. Though any card may be designated as wild, the wild card is commonly a joker (as in Joker Poker or Joker's Wild®) or a deuce (as in Deuce's Wild®). Wild card games are generally considered more exciting to play, but the payouts for most winning combinations are lower compared to the non-wild card games.

Because gaming device manufacturers are constantly seeking to increase both player enjoyment and the popularity of gaming machines, there is a continual need for new games that provide more opportunities for the player to win. Players are also attracted to new game schemes and features that encourage the development of new skills and new play patterns. Thus, though varieties of wild card video poker games exist, there exists a continuing need to provide new and exciting gaming devices and card gaming systems and methods.

From the discussion that follows, it will become apparent that the present invention addresses many deficiencies associated with the prior art while providing numerous additional advantages and benefits not contemplated or possible with prior art constructions.

### SUMMARY

The gaming system having a multi-card value wild card of the present invention affords the possibility of a player receiving a multi-card value wild card, which allows the player to use a single card as two or more cards, thus increasing the opportunity to have a winning hand. The multi-card value wild card can be played as two card values (one card played for two cards of any rank or suit) or, optionally, as multiple card values (one card played as three or four cards of any rank or suit). Variations presented allow one card to be played as two, three or four cards in any of a variety of poker or other card games. Methods of allocating the multi-card value wild card, hereinafter sometimes referred to as the “novel wild card,” to individual decks of playing cards are also disclosed.

The novel wild card is signified to the player by at least one signifying indicium. When the signifying indicium is generated and displayed, it indicates or designates a novel wild card. The signifying indicium may be a traditional card indicium or a novel indicium. For example, a traditional card may be predetermined and preassigned as a novel wild card based on a designated card rank, a designated card rank and suit, or the like. The use of a traditional card or cards designated as a novel wild card requires one or more novel wild cards per deck, while the use of a unique symbol allows the house to determine the percentage of decks that include the novel wild card.

A gaming system having a novel wild card system may be implemented in various ways. For example, when implemented as a video poker game, the gaming system may comprise one or more memory devices, one or more wager-input devices, one or more random number generators and one or more controllers. At least one controller provides randomized cards. When using the unique symbol as a novel signifying indicium, the controller(s) may allocate less than one novel wild card per deck of cards or one or more novel wild cards to individual decks of cards, with the output of the random number generator determining whether any of the novel wild card indicia are associated with a particular deck of cards.

Players are accustomed to video poker games with no wild cards or with a single-card value wild card that can be played as a single card of any value (of any rank, of any suit, or of any rank and suit). The multi-card value wild card system provides an exciting game scheme that increases player interest in the game play, that increases the player's potential to achieve high-ranking final hands, and that encourages the player to develop new skills due to the change in the play patterns caused by the novel wild card system compared to the traditional no-wild or single-card value wild card game. The player is much more confident of the likelihood of a winning result, though the payouts may be correspondingly reduced. A gaming machine incorporating the novel wild card system will be more popular due to the increased win opportunities.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a diagram illustrating an exemplary gaming machine with a first aspect of the novel wild card gaming system of the present invention.

FIG. 2 is a diagram illustrating components and systems of an exemplary gaming machine and multi-card value wild card system.

FIG. 3 is a flowchart illustrating a first method of the novel wild card system using a conventional card rank, or rank and suit, assigned as a multi-card value wild card(s) without adding additional cards to a fifty-two card deck.

FIG. 4 is a flowchart illustrating a second method of the novel wild card system that applies a probability factor to determine the number of decks having a multi-card value wild card.

FIG. 5 is a flowchart illustrating a third method of the novel wild card system that determines the number of decks having a multi-card value wild card by generating a plurality of decks of playing cards and randomly selecting an advantaged subset, with the subset receiving a multi-card value wild card(s).

FIG. 6 is a diagram illustrating an exemplary gaming machine showing variations of the novel wild card gaming system of the present invention.

FIG. 7 is a diagram illustrating an exemplary deal hand of a first game of an aspect of the novel wild card gaming system of the present invention.

FIG. 8 is a diagram illustrating an exemplary hold hand of the first exemplary game of the novel wild card gaming system of the present invention, which follows the deal hand of FIG. 7.

FIG. 9 is a diagram illustrating an exemplary replacement hand of the first exemplary game of the novel wild card gaming system, which follows the hold hand of FIG. 8.

FIG. 10 is a diagram illustrating an exemplary equivalent hand (an imaginary hand representing the final showdown result) of the first exemplary game of the novel wild card gaming system, which follows the replacement hand of FIG. 9.

FIG. 11 is a diagram illustrating an exemplary deal hand of a second exemplary game of an aspect of the novel wild card gaming system of the present invention.

FIG. 12 is a diagram illustrating an exemplary hold hand of the novel wild card gaming system, which follows the deal hand of FIG. 11.

FIG. 13 is a diagram illustrating an exemplary replacement hand of the novel wild card gaming system, which follows the hold hand of FIG. 12.

FIG. 14 is a diagram illustrating an exemplary equivalent hand (an imaginary hand representing the final showdown result) of the novel wild card gaming system, which follows the replacement hand of FIG. 13.

FIG. 15 is a diagram illustrating an exemplary deal hand of a third exemplary game of an aspect of the novel wild card gaming system of the present invention.

FIG. 16 is a diagram illustrating an exemplary hold hand of the novel wild card gaming system, which follows the deal hand of FIG. 15.

FIG. 17 is a diagram illustrating an exemplary replacement hand of the novel wild card gaming system, which follows the hold hand of FIG. 16.

FIG. 18 is a diagram illustrating an exemplary equivalent hand (an imaginary hand representing the final showdown result) of the novel wild card gaming system, which follows the replacement hand of FIG. 17.

FIG. 19 is a diagram illustrating the display portion of an exemplary gaming machine or of an online gaming website showing a first exemplary hand of a community card-type aspect of the novel wild card gaming system of the present invention, which is shown after the flop, turn, and river.

FIG. 20 is a diagram illustrating the display portion of an exemplary gaming machine or of an online gaming web site showing the exemplary equivalent hand (an imaginary hand representing the final showdown result) corresponding to FIG. 19 of the novel wild card gaming system.

FIG. 21 is a diagram illustrating the display portion of an exemplary gaming machine or of an online gaming web site showing a second exemplary hand of a community card-type aspect of the novel wild card gaming system of the present invention, which is shown after the flop, turn, and river.

FIG. 22 is a diagram illustrating the display portion of an exemplary gaming machine or of an online gaming web site showing the exemplary equivalent hand (an imaginary hand representing the final showdown result) corresponding to FIG. 21 of the novel wild card gaming system.

### DETAILED DESCRIPTION OF THE INVENTION

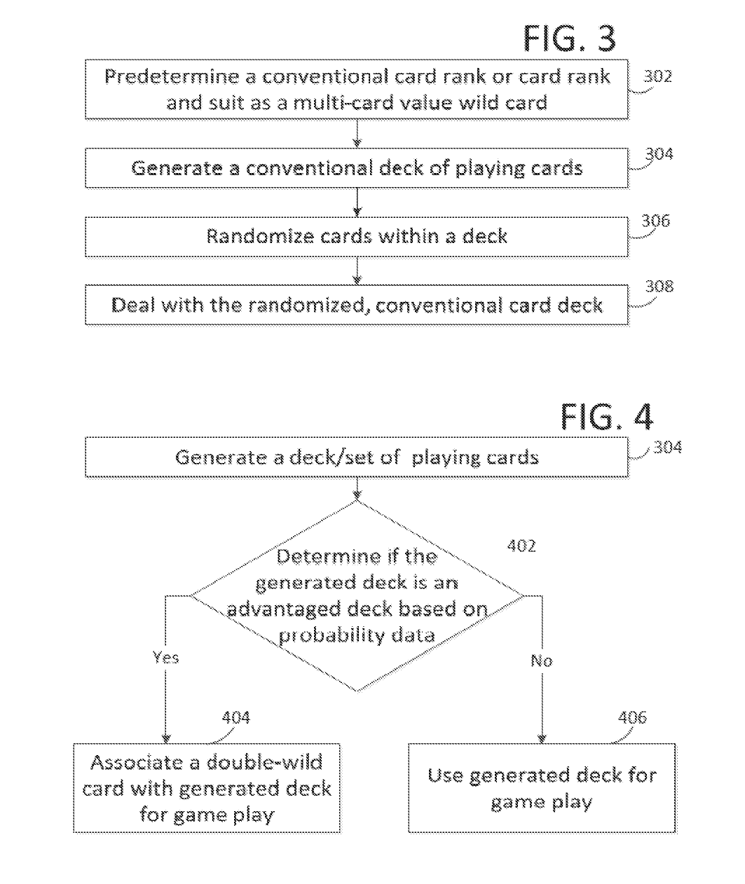

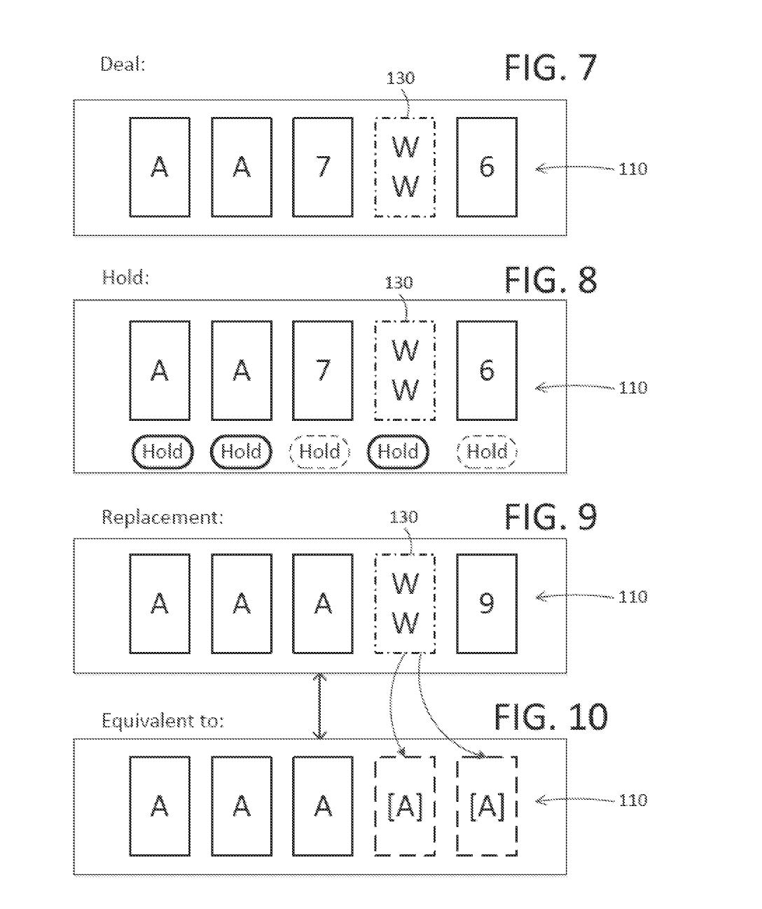

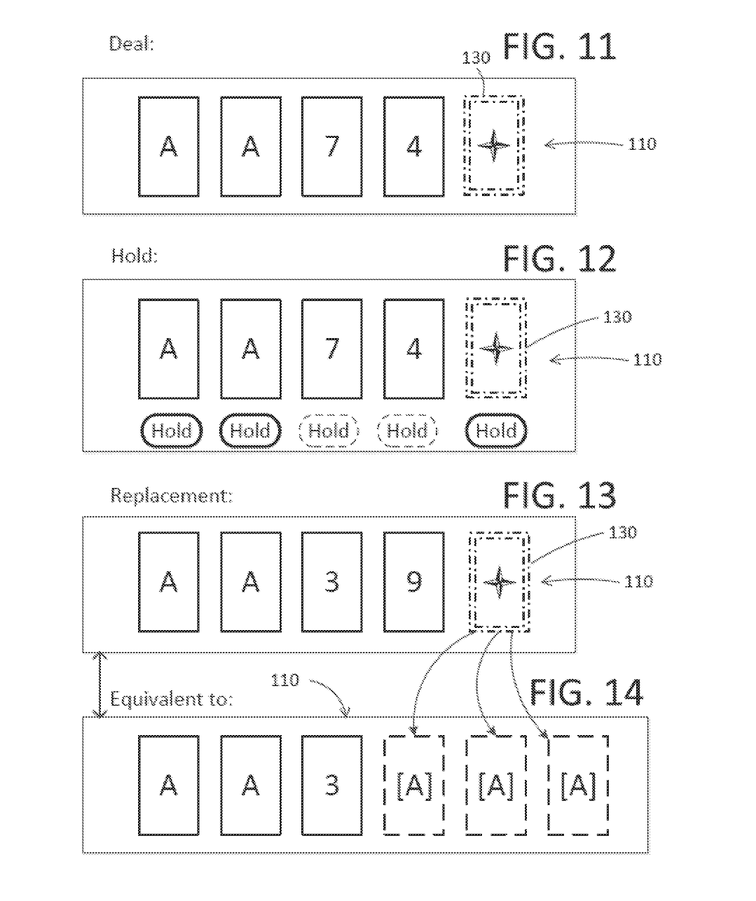

The gaming system having a multi-card value wild card of the present invention incorporates a multi-card value wild card that can be played, in one aspect, as two card values (one card played for two cards of any rank or suit, illustrated in the exemplary hand of FIGS. 7-10) or, optionally, in another aspect, as multiple card values (one card played as three or four cards of any rank or suit, illustrated in the exemplary hand of FIGS. 11-14). An individual deck used with the inventive method may have no cards, one card or multiple cards designated as a multi-card value wild card; methods of determining which decks will contain the novel wild card are illustrated in FIGS. 3-5.

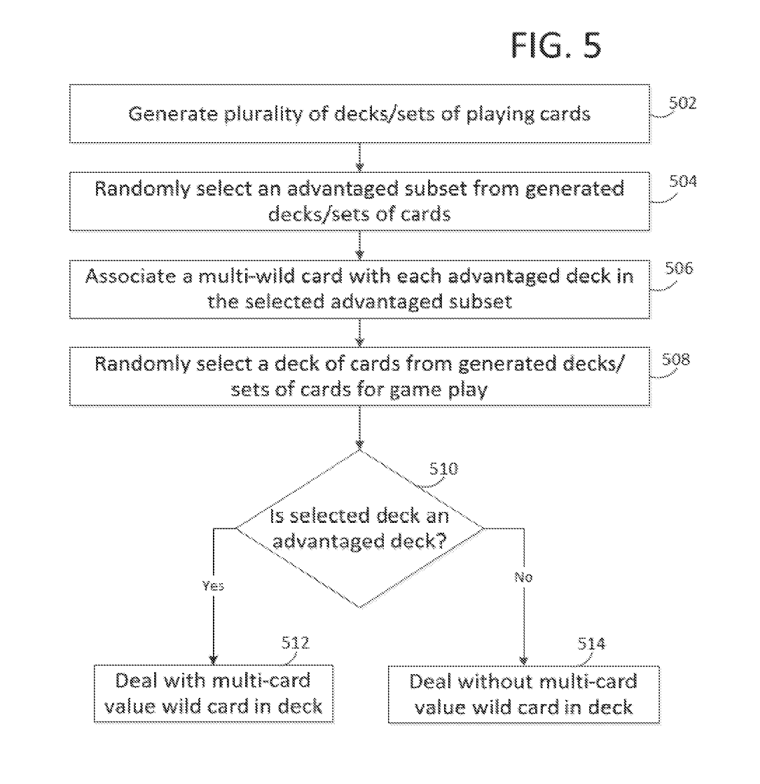

The novel wild card may be a card added to the generally fifty-two card deck or may be a conventional card within the generally fifty-two card deck which has been designated as the novel wild card. To indicate the receipt of the novel wild card to the player, a multi-card value signifying indicium 130, which may be a traditional card indicium or a novel indicium, is generated and displayed. When the conventional card is designated as the multi-card value wild card, the signifying indicium 130 may simply be a conventional card ranking and/or suit, such as, for example, any deuce, a queen of hearts or a jack of spades. In this case, a predetermined card rank or a predetermined card rank and suit is assigned as a multi-card value wild card as discussed in relation to the method of FIG. 3. When a multi-card value wild card is added to the deck, the signifying indicium 130 may be a symbol, marking or other distinctive “wild” designation as discussed in relation to the methods of FIGS. 4-5.

The novel wild card system may be used in any of a variety of poker game variants played on various types of video poker gaming machines and online poker websites. Though poker-type games are used herein for illustration of the inventive concept, the novel wild card may optionally be used in other games as well.

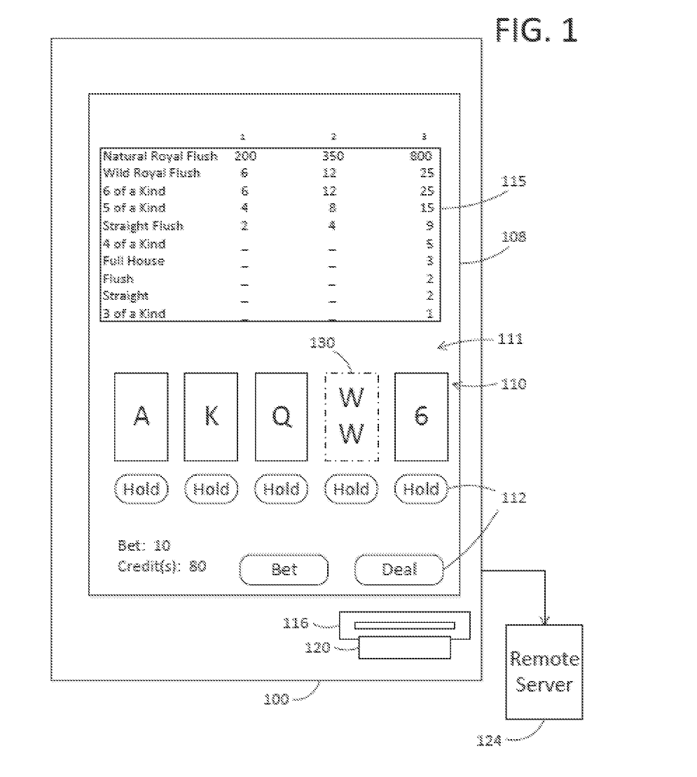

FIG. 1 illustrates an exemplary gaming machine 100 at which the novel wild card system may be provided. In one embodiment, the gaming machine 100 is configured to present one or more wagering games to a player that offer the possibility of an award of winnings. The winnings may be various items of value, including monetary payments (or representations thereof, such as an award of credits), coins and other currency, tokens, points, tickets, prizes or the like.

The gaming machine 100 may be configured to present various types or configurations of base poker-type games having the inventive features of the novel wild card system described herein. Typically, certain game outcomes will be designated as winning outcomes with a resultant award of winnings. The number of winning outcomes and the associated resultant award of winnings may vary dependent upon the winning percentage offered to the players as compared to the retained percentage of wagers that are retained by the gaming establishment.

The gaming machine 100 preferably includes at least one display device 108 configured to display game information. The display device 108 is preferably an electronic video display, but may be a mechanical, electro-mechanical, electronic display or the like. When the display device 108 is an electronic video display, it may comprise a cathode ray tube (CRT), high resolution flat panel liquid crystal display (LCD), projection LCD, plasma display, field emission display, digital micro-minor display (DMD), digital light processing display (DLP), LCD touch screen, a light emitting display (LED), organic light emitting display (OLED), elnk, or other suitable displays now known or later developed, in any of a variety of resolutions, sizes and formats.

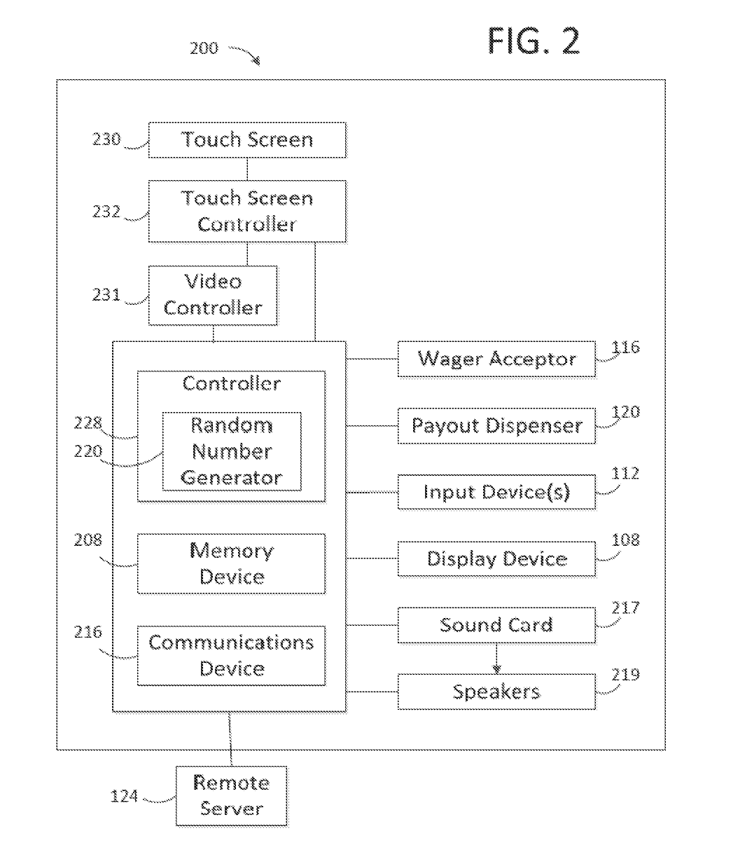

The display device 108 may be capable of presenting or displaying a wide variety of information, including images, pay tables 115, symbols and other indicia or information associated with play of a wagering game at the gaming machine 100. One or more regions of display device 108 may be configured as a touch screen 230 (FIG. 2) for receiving touch input from the player, such as the input device area 112 and/or the exemplary hand 110 display area 111. With regard to the novel wild card system, the display device 108 may present a predefined multi-card value signifying indicium 130 to the player to indicate to the player the reception of the multi-card value wild card. Separately, a supplementary notification or audio or video alert may also be presented by the gaming machine 100.

The gaming machine 100 may include one or more input devices 112 (such as input buttons, pull handle, a touch-screen display 230 (FIG. 2), joystick, touch-pad or the like) that may receive input from a player to facilitate game play. As shown for example, the gaming machine 100 of FIG. 1 includes input devices 112 in the form of buttons. In one or more embodiments, the input devices may be used to permit a player to play or interact with a game. An input device 112 may also be used to initiate play or start a game such as by causing a wager to be placed, the hand to start, or one or more cards to be dealt or presented to a player. The input devices 112 may also or alternatively be various other controls, such as sliders, switches, scroll bars, and the like implemented by physical devices or as on touch-enable screen 230 elements presented on the display 108.

The gaming machine 100 may also include one or more peripherals, such as a wager acceptor 116 for the purpose of receiving a wager. The wager acceptor 116 may be, for example, a coin or bill acceptor for accepting coins or paper money and/or a currency; a voucher/payout ticket scanner; a mobile payment scanner and/or acceptor; a card reader for reading player tracking cards, credit cards, ATM cards; or the like. Some other exemplary peripherals include one or more sound cards 210 (FIG. 2), speakers 219, video controllers 231, touch screen controller 232, and the like.

The gaming machine 100 will typically also include a payout dispenser 120 as a means for paying a player any winnings accumulated during game play. In one or more embodiments for example, an input device 112 may be configured to initiate a payout of the winnings, credits or other awards the player has earned. For example, the payout dispenser 120 may be a coin dispenser or a bill validator that delivers the proper number of coins or notes to the player. The payout dispenser 120 may also or alternatively be configured to dispense a ticket or other media, such as via a voucher/payout ticket printer, or electronically such as by transferring credits or currency to the player's bank account, mobile phone payment account or player tracking account.

The gaming machine 100 may be configured as a standalone device or be a component in a gaming system in communication with one or more external devices, such as through one or more communication devices. For example, the gaming machine 100 may be configured as a client-type device and obtain game code, game outcomes or both from a remote server 124 through network or other communications. A remote server 124 may be configured to perform accounting, player tracking, game generation, random number generation, or other functions. It is contemplated that the novel wild card system may be implemented at a remote server 124 in server-based gaming environments. In one aspect, the novel wild card system at a remote server 124 (or at a gaming machine) may be configured to randomly present a multi-card value signifying indicium 130 in a particular base game being played by a player at one of a plurality of gaming machines.

It is noted that a gaming machine may comprise a variety of devices configured to provide the features of the novel wild card system disclosed herein. For example, a gaming machine may be a computer, tablet, smartphone, game console or other portable or desktop computing device that functions as a standalone unit or in cooperation with one or more remote servers 124 to provide the novel wild card system disclosed herein.

FIG. 2 illustrates components of an exemplary novel wild card system 200 embodied in a gaming machine. As can be seen, the novel wild card 200 system may comprise one or more processors or controllers 228 for providing the functionality of the novel wild card system 200, such as by receiving player input and sending output signals for controlling the various components of a gaming machine 100 (such as generating game information for presentation by a display device 108). A controller 228 may comprise a microprocessor, chip, electronic circuit or the like, or be configured to execute one or more instructions to implement the functions of the novel wild card system 200 as detailed herein. In general, the novel wild card system 200 randomly allocates novel wild cards to particular players, such as by randomly presenting a card designated with a novel signifying indicium 130 during a player's base game. Additional details and embodiments describing operation of the novel wild card system 200 are provided below.

In one or more embodiments, the controller 228 may be configured to provide a base game at the gaming machine 100. For instance, the controller 228 may be arranged to send signals to generate the cards of a deck, to randomize the cards within the deck, to deal the cards and cause the display 108 to display the dealt cards, to control game play, to determining winning combinations and to cause the display 108 to display winning amount information as a pay table 115. The controller 228 may also communicate with input devices 112, peripherals, and one or more displays 108 (or other output devices) to allow a player to interact with and play the base game at the gaming machine 100. In addition, the controller 228 may determine if a round of game play has resulted in a win and, if so, the amount to be paid to the player for that win. In this case, only a single controller 228 may be needed in the gaming machine 100.

One or more memory devices 208 may be configured to store data necessary for the operation of the novel wild card system 200 and/or for the playing of the one or more base games. It is contemplated that various types of memory devices 208 may be used. For instance, a memory device 208 may utilize various data storage technologies, now known or later developed, including magnetic, optical, solid-state or flash-based storage.

Though the machine-readable code to implement and/or operate one or more base games and/or the novel wild card system 200 may be stored in a memory device 208. Alternatively, a controller 228 may be hardwired with such instructions. Information related to the play or execution of a base game and/or the novel wild card system 200, such as, but not limited to, credits, amounts wagered, pay tables 115, pay lines, odds for a winning outcome, cards/symbols dealt, jackpot amounts, bonuses, and randomly generated values may be stored in the memory device 208 as well.

The controller 228 may include or be in communication with one or more random number generators 220. In general, a random number generator 220 will be used to provide random game outcomes. For example, the random number generator 220 may be used to deal or present random cards to a player for a base game. With regard to the novel wild card system 212, a random number generator 220 may be used to allocate multi-card value wild cards, as will be described further below.

In some embodiments, one or more communication devices 216 may be provided to allow communication with external devices, such as a remote server 124 as described above. Alternatively, or in addition, a communication device 216 may be used to receive bonus information, such as bonus amounts. For example, the novel wild card system 200 may be in communication with a progressive bonus system that can be used to enhance the reward for certain winning results.

It is possible to have none, one or multiple multi-card value wild cards per deck. Steps used in three methods of determining the number of decks to receive a multi-card value wild card will be now be described with reference to the flow diagrams of FIGS. 3-5. As stated above, the controller 228 of the novel wild card system or the remote server 124 may be configured to control operation of the novel wild card system as set forth in the following.

FIG. 3 illustrates the instance in which a conventional card (or cards) within a conventional card deck (such as a fifty-two card poker deck) is utilized as a novel wild card. The card or cards so designated may be based on a card's rank or a card's rank and suit. An example of the novel wild card based on a card's rank is the instance in which all deuces are predetermined and predesignated as novel wild cards, yielding four novel wild cards within a single deck. An example of the novel wild card based on both the card's rank and suit, is the instance in which the deuce of spades is predetermined and predesignated as the single novel wild card within an individual deck.

At a step 302, a predetermination is made as to which conventional card is to be associated as the novel wild card. This predetermination is indicated to the player, such as via display screen 108. The system may generate 304 a single deck or a plurality of decks of playing cards for use in play of a base game. Each deck will be a complete deck to allow play of the base game according to its rules. Though the decks may be different based on the type of base game being played, it is anticipated a complete standard fifty-two card deck will be generated as is generally used in a traditional poker game. The decks may be generated at different times. For example, in one aspect, the decks may be generated when a new base game begins, such as when a player places a wager. In another exemplary aspect, the decks may be generated before a base game begins (i.e., generated at the end of one base game for use in the next round or game). The cards are randomized or shuffled 306. This randomization may occur at the time of generation of the deck or as a separate step, such as by adding the individual card ranking and suit to each card in the deck in a random order. It is contemplated that each deck may comprise the same cards in the same or a different order.

The cards of the conventional deck are then dealt 308. If desired, the predetermined card to be designated as the novel wild card may be further indicated to the player by the addition of a multi-card value signifying indicium 130 to the conventional card. For instance, all deuces may have, in addition to the number “2” and the suit designation, an additional distinctive “wild” designation for emphasis to the player.

The method of FIG. 3 (using a predetermined, preassigned conventional card) requires that at least one card per deck is designated as a multi-card value wild card. In contrast, the methods of FIGS. 4-5 (using an added card to the deck) allow for less than one card per deck to be designated as a multi-card value wild card, as it is not necessary to add the novel wild card to each and every deck.

FIGS. 4-5 illustrate instances in which at least one novel wild card is added to at least some conventional fifty-two card decks that will be prepared for play. This at least one novel wild card may assume the form of a conventional joker or may be designated with non-conventional novel wild card indicia 130. FIGS. 4-5 show two methods in which a percentage of all decks receive the novel wild card. The percentage may be over or under 100%.

In FIG. 4, a deck is generated 304, either before a new base game begins or at the time the new base game begins. A probability factor is applied 402 to determine if the generated deck is an advantaged deck (a deck to which at least one novel wild card will be added). For instance, the house may decide that 75% of all decks should include a novel wild card, so that a probability factor may be applied to the generated deck. The likelihood of the novel wild card appearing in the game play can be varied by the selection of this probability factor, based on the desired house advantage. If the deck is determined to be advantaged, at least one novel wild card will be associated with the generated deck before randomization and dealing (as described before) of the advantaged deck. If the deck is not found to be advantaged, the generated deck is randomized before the dealing of the conventional non-advantaged deck without a novel wild card.

FIG. 5 illustrates a second method to associate the novel wild card with an advantaged deck. A plurality of decks/sets of playing cards are generated 502, and then an advantaged subset (having a predetermined number of advantaged decks per the total generated decks) is randomly selected 504 from the plurality of decks/sets generated. For instance, a subset may include only a single advantaged deck or multiple advantaged decks. This allocates the novel wild card to only the selected number of advantaged decks that are within the subset.

The one or multiple novel wild cards are then associated 506 with each advantaged deck and inserted at one or more random positions within the advantaged deck. For example, if one thousand decks are generated, a subset of one hundred may be selected as advantaged decks with a single novel wild card added to each of the advantaged decks.

Then a deck of cards is randomly selected 508 from the total generated decks/sets of cards. The selected deck is then randomized and dealt as described above. If the selected deck is an advantaged deck, the play proceeds with the possibility that the included novel wild card will be dealt for play.

In the methods of FIGS. 4-5, when the novel signifying indicium 130 has a non-conventional designation, the novel wild card will typically be distinguishable from cards used in the base game, allowing the player to easily determine he has received the novel wild card. The novel wild card designation 130 may be, for instance a symbol (such as a star, icon, image, geometric shape or the like) or may be a color (such as a portion or entire background of the card having a gold color) or may be a display enhancement (such as a flashing or otherwise visually enriched presentation).

Though described above in a particular sequence, the steps of the methods in FIGS. 3-5 may occur in different orders within the spirit and scope of the novel wild card system disclosed herein.

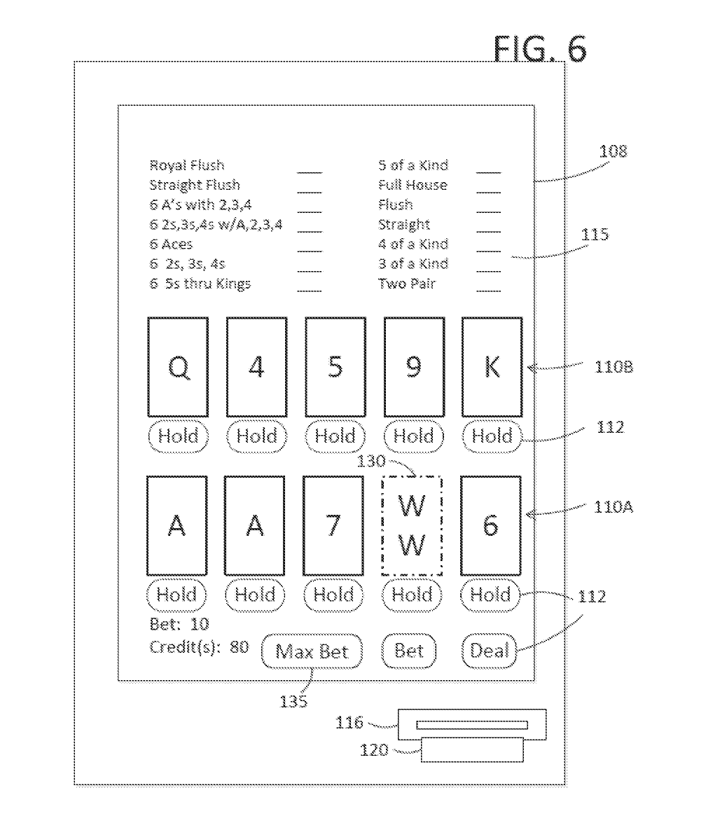

FIG. 6 illustrates that the novel wild card system can be used in multi-hand poker, can be used with a kicker, and can require an extra wager to be input for the player to be eligible to have a novel wild card included in any deck. The two hands of the multi-play poker are shown as two hands 110A, 110B, which may both have associated input devices 112. The payout table shows the payouts including a kicker, where the kicker is, as in double-double bonus poker, an ace, 2, 3, or 4 that adds an extra bonus payoff to specific four-of-a-kind hands.

FIG. 6 also includes a “max bet” button. In some aspects of the invention, there is a minimum threshold to enable the novel wild card feature. In this case, the controller 228 first makes a check to see if the minimum threshold has been reached before associating a multi-card value wild card with an advantaged deck, as described in FIGS. 4-5. The minimum threshold may be, for example, the maximum bet; in this case, the player must bet the max bet by activating the max bet button 135 before the controller 228 will make the player eligible for the multi-card value wild card feature. In another aspect, the minimum threshold is an extra wager placed on top of a max bet wager. The number of additional credits beyond the “max bet” needed to be wagered to obtain eligibility may be varied by game designers to suit game play. For example, the number of additional credits beyond the “max bet” needed to be wagered to obtain eligibility may be set to be one credit, three credits, or more than three credits.

In yet another aspect, the total amount of the wager may be associated with a higher chance of receiving a novel wild card; for example, if the player bets $100, the controller 228 uses a proportionality factor of 90%, but if the player bets $10, the controller 228 uses a proportionality factor of 50%.

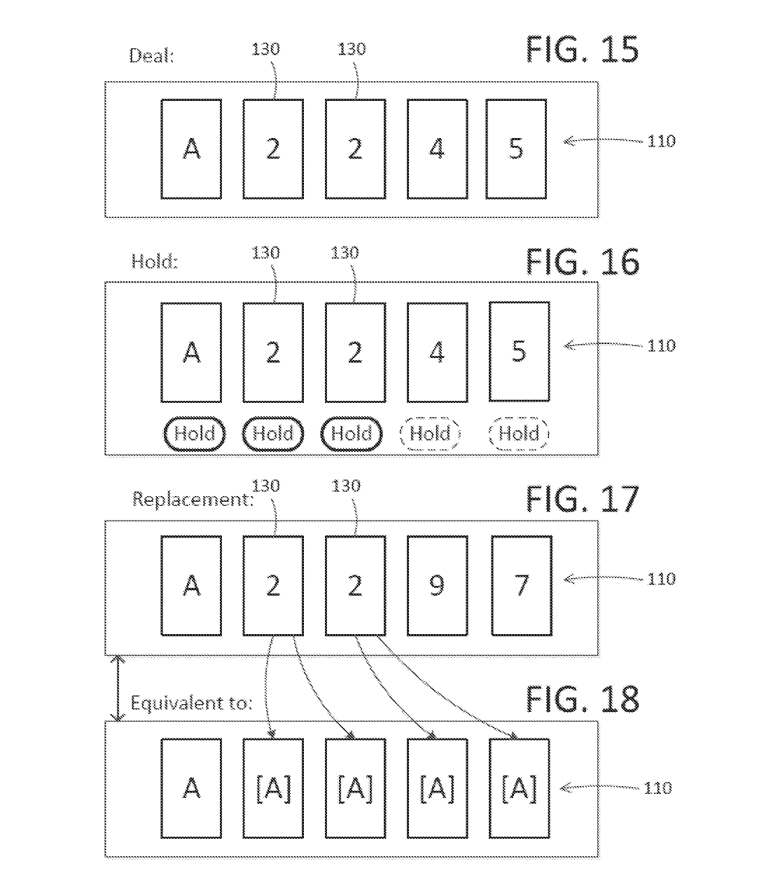

The novel wild card system can be used with any of the variants of poker-type games. These include the general classes of straight poker, stud poker, draw poker (as in FIGS. 1, 6-18), and community card poker (as in FIGS. 19-22), but also include modified games within these categories, such as single-hand (as in FIG. 1) or multi-hand video poker (as in FIG. 6) or games played with a kicker (as in the pay table 115 of FIG. 6) or without a kicker (as in the pay table 115 of FIG. 1).

FIGS. 7-22 illustrate exemplary hands presented to further the understanding of the novel wild card system.

FIGS. 7-10 show an aspect of the novel wild card system in which a novel wild card is playable as a dual-card value wild card. The player receives the deal hand shown in FIG. 7 and holds the two aces and the dual-card value wild card, as seen in FIG. 8. The player receives one more ace when the replacement cards of FIG. 9 are dealt. The final hand of FIG. 9 is equal to the equivalent hand shown in FIG. 10—with the payout based upon the equivalent hand of FIG. 10. The dual-card value wild card of FIG. 9 is converted to two additional aces, giving the player a hand ranking of five-of-a-kind with five aces. The conversion to the two additional aces may be only an imaginary conversion within the controller 228 which is then used by the controller 228 to calculate the payout or may optionally be displayed on display screen 108 in a manner to notify the player of the equivalency. For example, small cards may appear within the hand display area 111 above the exemplary hand 110, the dual-card value wild card and the nine card may be removed from the display and replaced with the two additional aces display, or other visual display methods and/or auditory notification methods may be used. Additionally, the controller 228 may light up the winning hand rank on the pay table 115.

FIGS. 11-14 show an aspect of the novel wild card system in which a novel wild card is playable as a tri-card value wild card and in which the equivalent hand has more than five cards, due to the multi-card value wild card conversion. The player receives the deal hand as shown in FIG. 11; the player then holds the two aces and the tri-card value wild card, as seen in FIG. 12. The player receives one more aces in the replacement cards shown in FIG. 13. The final hand of FIG. 14 is equal to the equivalent hand shown in FIG. 13, with the tri-card value wild card of FIG. 13 is converted to three additional aces, giving the player a hand ranking of six-of-a-kind aces, which illustrates that the novel wild card may be played for cards that duplicate cards already in the deck or even already in play. Thus FIG. 14 illustrates that the final hand of five cards of FIG. 13 may be equivalent to more than the five actual cards. As discussed above, the conversion may be only within the controller 228 for use as the controller 228 determines the payout, or may optionally be displayed on display screen 108 in a manner to notify the player of the equivalency. The equivalency may also be indicated to the player by the lighting of the winning hand ranking on the pay table 115 by the controller 228.

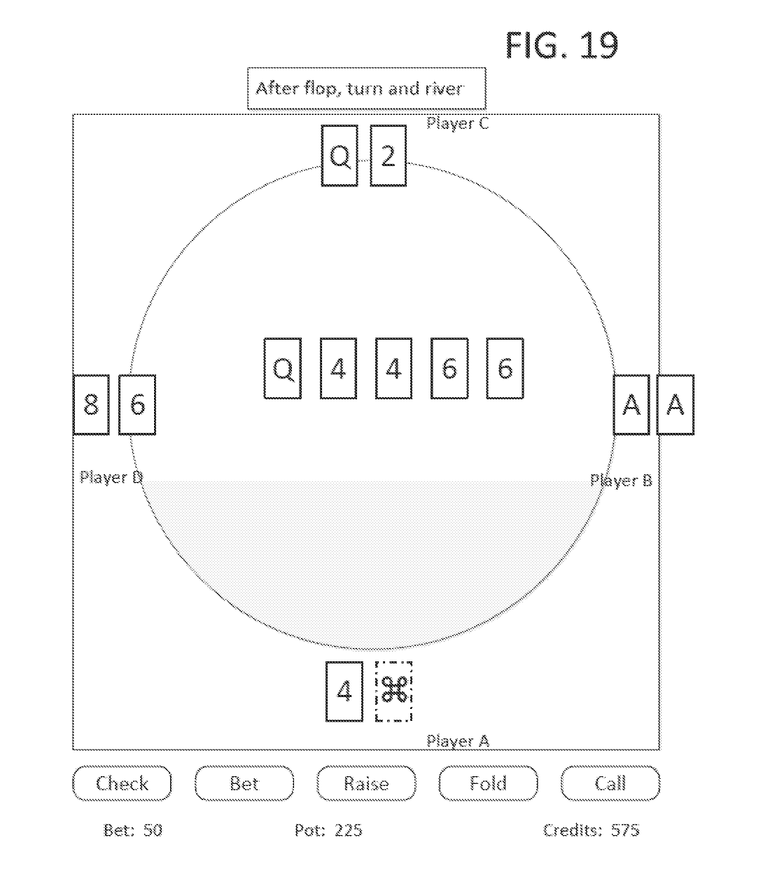

FIGS. 11-14 show an aspect of the novel wild card system in which a predetermined card rank (shown here as deuces) is predetermined and preassigned as a multi-card value wild card as discussed in relation to the method of FIG. 3. In this exemplary play, each of the two deuces held in the final hand of FIG. 17 (which are equivalent to two cards of any rank, or any rank and any suit) are converted to ace equivalents, thereby giving the player a result of five-of-a-kind aces.

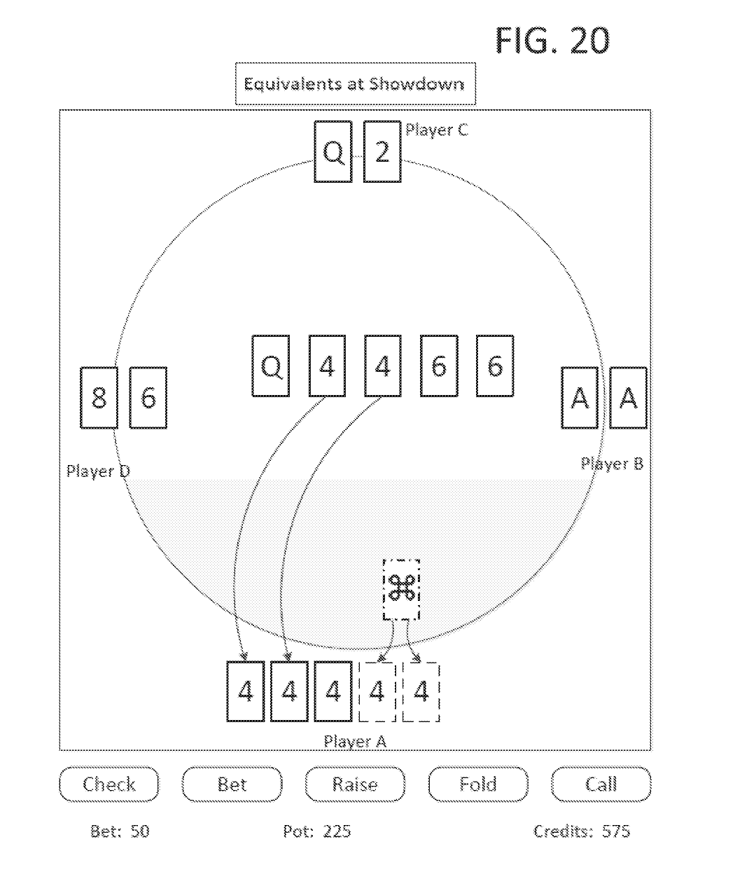

FIGS. 19-20 show an aspect of the novel wild card system in which at least one novel wild card is added to a standard deck that is used to play a community card game, such as Texas Hold 'em, and in which the novel wild card is dealt as a hole card. Player A has a novel wild card as a hole card. After the flop, turn and river, Player A's equivalent hand at the showdown is shown in FIG. 20. The novel wild card of Player A is converted to two additional 4's that add to the three natural 4's to create a hand with a ranking of five-of-a-kind.

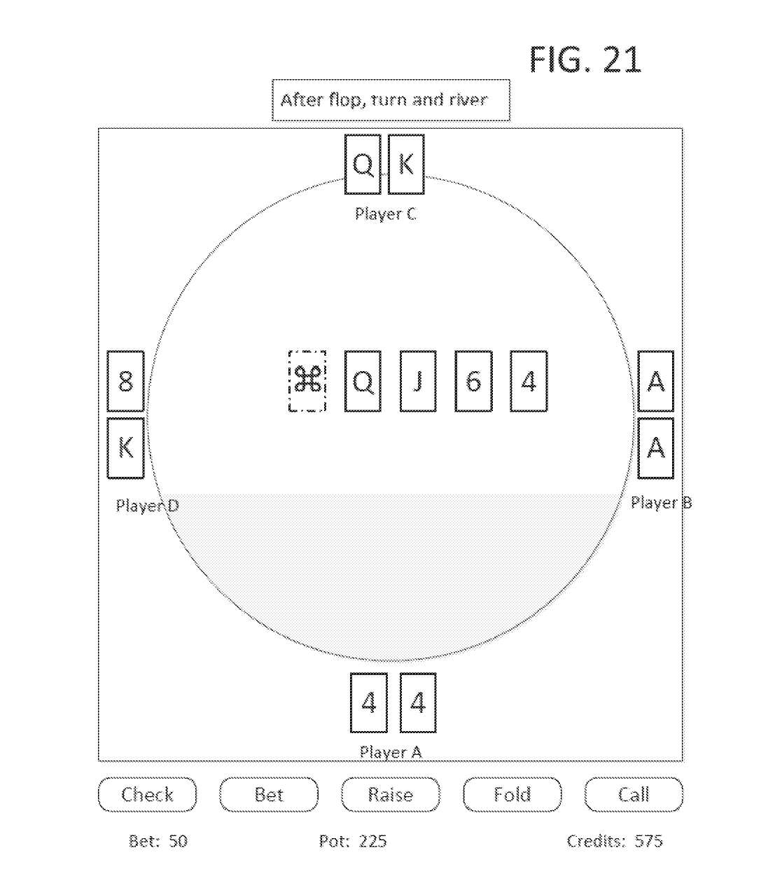

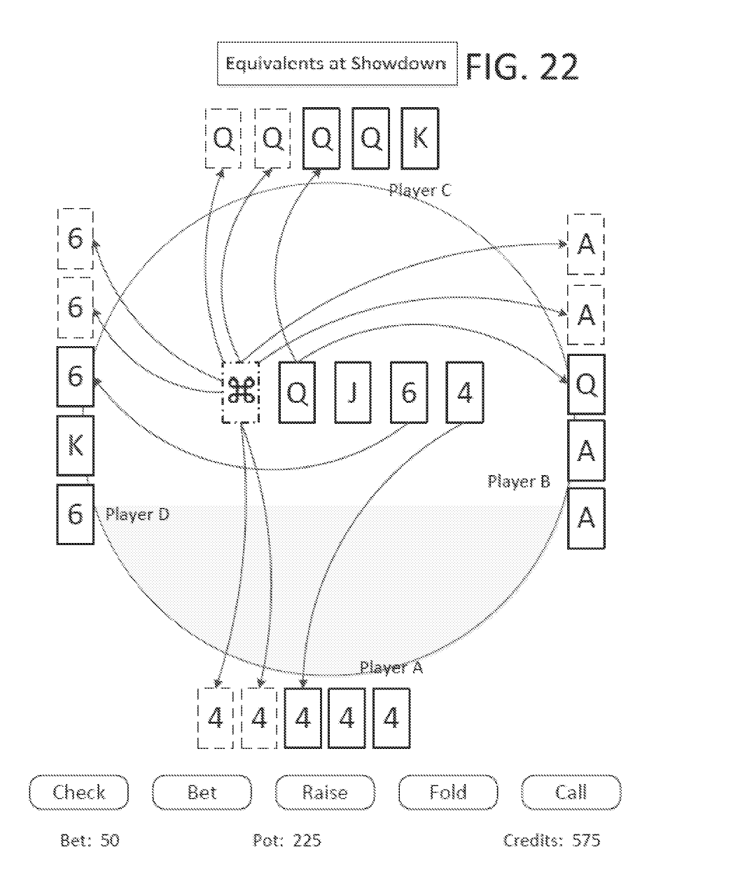

FIGS. 21-22 show another community card aspect of the novel wild card system but, in contrast with FIGS. 19-20, with the novel wild card on the table. FIG. 21 shows that at the river, the novel wild card is dealt face up on the table. Therefore, each of the players are eligible to use the novel wild card to make the best possible hand with their hole cards. The resulting equivalent hands at the showdown are shown in FIG. 22.

Though the novel wild card system has been described in relation to poker-type card games, the concept of the multi-card value wild designation can be applied similarly to other card games and to non-card games, such as keno. Additionally, though the multi-card value wild card has been described as being equivalent to multiple cards of any value, based on the desire of the game provider the potential equivalent cards equally well may be limited to particular values (rank, suit, or rank and suit), i.e. the multi-card value wild card may be played as a “bug.” Further, though the novel wild card system has been described with the controller 228 determining the best application of the novel wild card to provide the player with the highest-ranking hand possible, in other aspects, the gaming device may have a player selector-type of input device 112 that allows the player to designate the two or more cards that are equivalent to the novel wild card. In this aspect, though the novel wild card may have been more profitably used as other cards, the player is allowed to choose cards that produce a hand of a lower ranking. For example, in FIG. 9, the player could use the player selector input device to designate that the novel wild card be played as two kings; this would result in a full house, which is a lower-ranking hand than the five-of-a-kind hand determined by the controller 228. This aspect may provide an advantage to the house, as the best hand may not always be determined by players.

While various embodiments of the invention have been described, it will be apparent to those of ordinary skill in the art that many more embodiments and implementations are possible that are within the scope of this invention. In addition, the various features, elements and embodiments described herein may be claimed or combined in any combination or arrangement.

We claim:

1. A gaming system comprising:
at least one input device;
at least one display device;
at least one processor in communication with said at least one input device and said at least one display device;
at least one memory device storing a plurality of instructions which, when executed by said at least one processor, cause the at least one processor to operate with said at least one input device and said at least one display device for a play of a poker game; and
a plurality of playing cards adapted to be selected by said processor and displayed by said display device, wherein at least one of said plurality of cards is adapted to be a multi-card value wild card, said multi-card value wild card being playable for at least two card values.

2. A gaming system comprising:
at least one input device;
at least one display device;
at least one processor in communication with said at least one input device and said at least one display device;
at least one memory device storing a plurality of instructions which, when executed by said at least one processor, cause the at least one processor to operate with said at least one input device and said at least one display device for a play of a poker game including:
(a) receiving a wager from a player;
(b) receiving a signal input from the player to begin play of the hand;
(c) generating an initial deck of playing cards;
(d) determining if said initial deck of playing cards is an advantaged set of playing cards, wherein if said initial set of playing cards is an advantaged set of playing cards associate a multi-card value wild card with said initial set of playing cards to generate a modified set of playing cards and if said first set of playing cards in not an advantaged set of playing cards do not associate a multi-card value wild card with said first set of playing cards to generate said modified set of playing cards;
(e) generating and displaying a hand of a plurality of displayed cards from said modified set of playing cards;
(f) displaying a payoff table;
(g) determining a rank value of the equivalent poker hand by using said multi-card value wild card to represent at least two card values to maximize the rank value;
(h) determining a payoff from said payoff table in step (f) using the rank value determined in step (g) and the amount of the bet received in step (a) as indices to the payoff table;
(i) awarding a payoff to the player as determined in step (h); and
(j) in successive hands, repeating steps (a) through (i).
